(19) United States
(12) Patent Application Publication
(10) Pub. No.: US 2006/0127157 A1
(43) Pub. Date: Jun. 15, 2006

(54) Tire polishing system

(76) Inventor: Louis Sims, Amory, MS (US)

Correspondence Address: Kristin L. McCandless, 705 Shadowood Lane, Starkville, MS, 39759-4133, US

(21) Appl. No.: 11/304,199

(22) Filed: Dec. 14, 2005

Related U.S. Application Data
(60) Provisional application No. 60/636,716, filed on Dec. 15, 2004.

(51) Int. Cl. A46B 11/00; B43M 11/06

(52) U.S. Cl. 401/11; 401/207

(57) ABSTRACT

The present invention provides a system and device for applying liquid tire surface treatment products, including dressing products, to the sidewall of a tire in a more efficient, convenient, and mess-free method. The invention provides for an applicator that has a concave curvature, with an applicator body and an applicator head. Both the applicator head and applicator body have beveled inward edges. The present invention also provides for the substantially universal connector, between the applicator body and product container, such as to fit most conventional product containers commercially offered and available to consumers of tire surface treatment products. Additionally, the invention provides a product delivery channel that is in substantial contact with the applicator head, such that the distribution of flow of tire surface treatment product is not restricted between the delivery channel and the applicator head.

### CROSS-REFERENCE TO RELATED APPLICATION

This application claims the benefit of U.S. Provisional Application Ser. No. 60/636,716 filed Dec. 15, 2004. The entire disclosure of this priority application is incorporated herein by reference in its entirety.

### FIELD OF THE INVENTION

The present invention relates to brushes and cleaning devices. More particularly, this invention relates to a system and device for applying a cleaning or polishing product to a tire.

### BACKGROUND OF THE INVENTION

Generally, liquid tire surface treatment products, such as tire dressing, are applied to a tire directly from a spray bottle or first applied to a cloth or sponge and then applied to the tire. Either method can result in the misapplication of the product. Spraying the product directly onto the tire can result in overspray and uneven application. Overspray can leave an unwanted film or even damage adjacent vehicle parts. Additionally, overspray can cause damage by getting on the user or the user's clothing.

Other tire polish products can be applied to the vehicle tire by first applying the product to a cloth or sponge and then using the product soaked cloth or sponge to apply the product to the tire. This application process can also result in uneven application of the product. Additionally, the process of applying the product to the cloth or sponge can also result in getting the product on the user and or on the user's clothing.

Overall, the current methods available to apply liquid tire dressing products are inconvenient and messy, typically, resulting in the misapplication of the product causing the user to become very frustrated.

Therefore, it is an object of this invention to provide a system and device to apply liquid tire dressing products in a more efficient, convenient, and mess-free method. An additional object of this invention is to provide a device that can be used with most conventional product containers commercially offered and available to consumers of tire surface treatment products.

### SUMMARY OF THE INVENTION

In accordance to a preferred embodiment hereof, this invention provides a tire product applicator device for the more efficient, convenient, and mess-free method of applying tire surface treatment products, including tire polish, to a tire sidewall where the device includes an applicator body for aiding in delivery of tire surface treatment product from a product container to a tire sidewall and an applicator head, having at least one mounting side and at least one working side wherein the at least one working side comprises concave curvature, for complementally applying tire surface treatment product to a tire sidewall. The tire applicator device also includes at least one connector for connecting the applicator body to a product container and a product delivery channel for delivering tire surface treatment product from a product container through the at least one connector and applicator body to the applicator head. Moreover, the at least one connector is substantially universal, structured and arranged to fit most conventional product containers commercially offered and available to consumers of tire surface treatment products.

It also provides for such a tire product applicator device wherein the product delivery channel is in substantial contact with the applicator head, such that the distribution of flow of tire surface treatment product is not restricted between the delivery channel and the applicator head. Further, it provides such a tire product applicator device wherein such at least one connector comprises flexible material, such that the at least one connector can be stretched to fit over various sizes of product container openings. Additionally, it provides such a tire product applicator device wherein such at least one connector comprises at least one connector thread.

In addition, the present invention provides such a tire product applicator device wherein the applicator body comprises a plurality of edges that are beveled on an inward angle. Further, it provides such a tire applicator device wherein the applicator head further comprises a plurality of edges that are beveled on an inward angle. Moreover, it provides such a tire product applicator device wherein such applicator body further comprises formed plastic. The invention also provides such a tire product applicator device wherein the applicator head further comprises material sufficiently porous to allow tire surface treatment product transfer through the applicator head to a tire sidewall.

Additionally, the invention provides such a tire product applicator device further comprising at least one mounting support for mounting the mounting side of the applicator head to the applicator body. It also provides for such a tire product applicator device wherein the mounting side of the applicator head is mounted to the at least one mounting support using adhesive. Further, the invention provides such a tire product applicator device wherein the tire applicator device is about 1 inch in width, about 4 inches in length, and about 5 inches in height.

In accordance with another preferred embodiment hereof, this invention provides a kit comprising at least one tire product applicator device, comprising: applicator body for aiding in delivery of tire surface treatment product from a product container to a tire sidewall; at least one applicator head, comprising a mounting side and a working side wherein the working side comprises concave curvature, for complementally applying tire surface treatment product to a tire sidewall; at least one connector for connecting the applicator body to a product container; product delivery channel for delivering tire surface treatment product from a product container through the at least one connector and the applicator body to the at least one applicator head; and wherein the at least one connector is substantially universal, structured and arranged to fit most conventional product containers commercially offered and available to consumers of tire surface treatment products; at least one storage container; and at least one set of use instructions. Even further, it provides such a kit further comprising at least one product container containing tire surface treatment product, wherein the at least one product container comprises a conventional container, such as commercially offered and available to consumers of the tire surface treatment products.

Additionally, it provides such a kit wherein the product delivery channel is in substantial contact with the at least one applicator head, such that the distribution of flow of tire surface treatment product is not restricted between the delivery channel and the at least one applicator head. Further, it provides such a kit wherein the at least one connector comprises flexible material, such that the at least one connector can be stretched to fit over various sizes of product container openings. It also provides such a kit wherein the at least one connector comprises at least one connector thread.

Moreover, the invention provides such a kit wherein the applicator body comprises a plurality of edges that are beveled on an inward angle. It also provides such a kit wherein such at least one applicator head further comprises a plurality of edges that are beveled on an inward angle. Further, it provides such a kit wherein the at least one tire product applicator device further comprises at least one mounting support for mounting the mounting side of the at least one applicator head to the applicator body. Additionally, it provides such a kit wherein the mounting side of the at least one applicator head is mounted to at least one mounting support using adhesive.

### BRIEF DESCRIPTION OF THE DRAWINGS

FIG. 1 is a perspective view of the tire product applicator system, according to a preferred embodiment of the present invention, showing a user applying product to a tire.

FIG. 2 is an enlarged view of the tire product applicator system of FIG. 1.

FIG. 3 is a side view of the tire product applicator of the system of FIG. 1.

FIG. 4 is a top view of the tire product applicator of FIG. 3.

FIG. 5 is a cross sectional view of the tire product applicator of FIG. 3.

FIG. 6 is a cross-sectional view of the tire product applicator, according to another preferred embodiment of the present invention.

### DETAILED DESCRIPTION OF THE PREFERRED EMBODIMENTS OF THE INVENTION

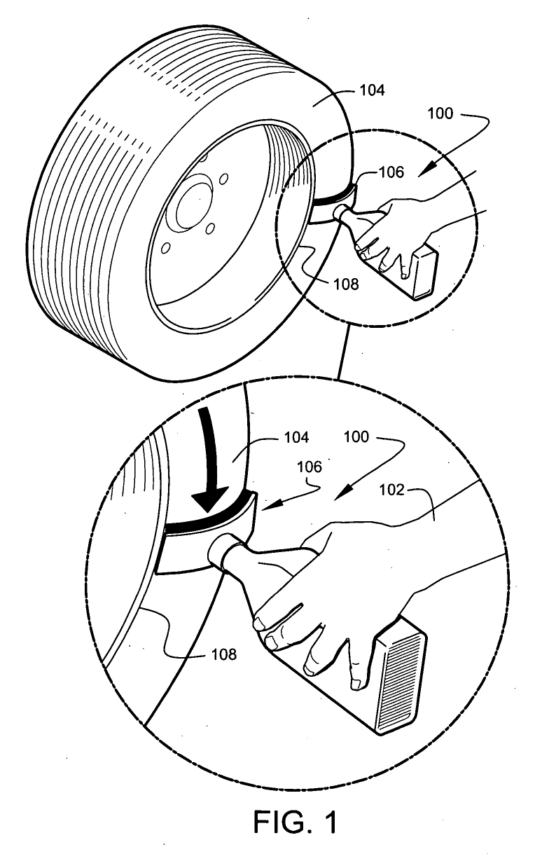

This invention is a system and device for a more efficient, convenient, and mess-free method of applying tire surface treatment products, including tire polish, to a tire sidewall. Referring to FIGS. 1 through 5, there is illustrated a preferred embodiment of the present invention generally designated as tire product applicator system 100. As shown in FIG. 1, tire product applicator system 100 is used by user 102 to apply liquid tire polish to tire sidewall 104. Preferably, the length of tire product applicator 106 is sized such that the entire height of tire sidewall 102 is coated in one pass of the tire product applicator 106, as shown, without getting any product on rim 108. The length of tire polish applicator 106 is preferably about 4 inches. Accordingly, under appropriate circumstances, the length of tire polish applicator 106 may vary, depending on the type of tire the tire product applicator 106 is sized for, passenger vehicle or truck, manufacture of tire product applicator 106, materials used, etc. Also, as shown in FIG. 1, user 102 preferably holds product container 202 to apply product to tire sidewall 104. However, user 102 may apply product to tire sidewall 104 by also holding tire product applicator 106, whichever is more convenient for user 102. Product container 202 is preferably a product container that is commercially offered and available to consumers of tire surface treatment products.

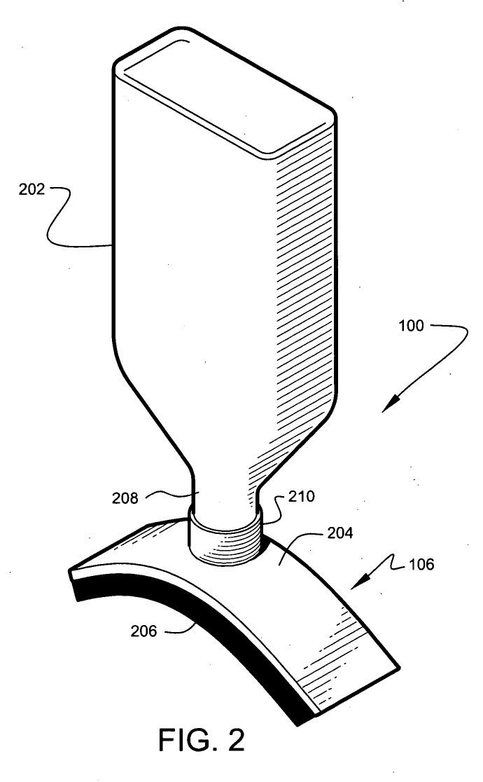

FIG. 2 is an enlarged view of the tire product applicator system 100. The tire product applicator system 100 comprises the tire product applicator 106 and product container 202. As shown in FIG. 2, tire product applicator 106 includes applicator body 204 and applicator head 206. Both applicator body 204 and applicator head 206 preferably have a concave curvature to fit the curvature of tire sidewall 102. It is this curvature that allows for better, more even application of product on tire sidewall 102. Accordingly, under appropriate circumstances, the concave curvature of applicator body 204 and applicator head 206 may vary as with the length of tire polish applicator 106, depending on the type of tire the applicator body 204 and applicator head 206 is sized for, passenger vehicle or truck, manufacture of applicator body 204 and applicator head 206, materials used, etc. The overall height of applicator body 204 and applicator head 206 together, as shown, is preferably about 5 inches. Preferably, as shown, product container 202 and tire product applicator 106 are connected at the product container neck 208 by applicator connector 210. Applicator connector 210 is preferably formed integral to applicator body 204. However, under appropriate circumstances, such as manufacturing methods, material used, etc., the applicator connector 210 may be attached to the applicator body 204 in a different manner. Other appropriate methods of attaching applicator connector 210 to applicator body 204 are well known by those skilled in the art.

Preferably, applicator body 204 is formed from a hard plastic for durability and ease of manufacture. Upon reading the teachings of this specification, those with ordinary skill in the art, will now understand that, under appropriate circumstances, considering issues such as user preferences, economic considerations, etc., other materials for the applicator body 204, may suffice. For example, the applicator body 204 may be made of varying materials, such as a more flexible plastic for better fit around the tire or formed cardboard, etc., depending on the intended use and need for durability, manufacturing process, etc. Applicator head 206 is preferably a porous material, such as sponge, to permit the absorption of product and ease of transfer of the product onto the varying curvatures of tire sidewall 104. Under appropriate circumstances, accordingly, applicator head 206 may be made from varying material, such as dense synthetic foam, etc., depending on the intended use and need for durability (throw away or not), ability to be cleaned, manufacturing process, etc.

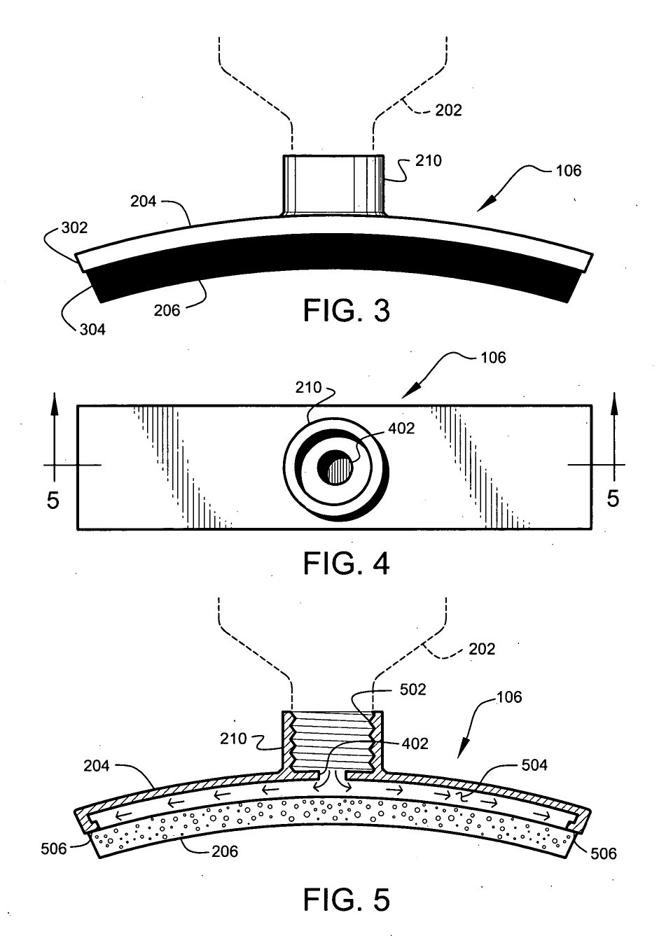

FIG. 3 is a side view of the tire product applicator 106. As shown in FIG. 3, both the applicator body edge 302 and the applicator head edge 304 are preferably beveled at an inward angle. This beveled inward angle allows the product to be applied to tire sidewall 104 such that the product is not misapplied to the rim 108 (see FIG. 1). Additionally, the applicator body edge 302 and applicator head edge 304 are preferably beveled at an inward angle on both sides, as shown in FIG. 3, of tire product applicator 106 such that the tire product applicator system 100 can be effectively used with either beveled side of the tire product applicator 106 close to rim 108. Under appropriate circumstances, accordingly, the beveled inward angle of applicator body edge 302 and applicator head edge 304 may vary, such as at a lesser angle or at different angles from each other, depending on intended use, manufacturing process, etc. Applicator head 206, as shown in FIGS. 3 and 5, is preferably sized slightly smaller than applicator body 204. However, under appropriate circumstances, applicator head 206 may vary in size, such as sized larger than applicator body 204 for use on a larger tire sidewall 102 while using a standard sized applicator body 204 (e.g., interchangeable, different sized, applicator heads 206 with use of a standard, one size, applicator body 204), etc.

A top view of tire product applicator 106 is shown in FIG. 4. As shown, preferably the length of tire product applicator 106 is greater than its width. Preferably, the width of tire product applicator 106 is about 1 inch. However, under appropriate circumstances, the width of tire product applicator 106 may be greater or smaller, depending on the type of tire the tire product applicator 106 is sized for, passenger vehicle or truck, manufacture of tire product applicator 106, materials used, etc. Applicator body aperture 402, as shown in FIG. 4, allows the flow of product from product container 202 to applicator head 206 through applicator body 204. Preferably, applicator body aperture 402 is smaller in diameter than applicator connector 210 to regulate the flow of product to applicator head 206. Accordingly, under appropriate circumstances, the diameter of the applicator body aperture 402 may vary, depending on the size of the tire product applicator 106, etc. Additionally, upon reading the teachings of this specification, those with ordinary skill in the art, will now understand that, under appropriate circumstances, considering issues such as user preferences, economic considerations, etc., other methods of regulating the flow from the product container 202, may suffice. For example, a one way valve may be used, etc.

FIG. 5 is a cross sectional view of tire product applicator 106. Applicator connector threads 502 are located on the internal side of the applicator connector 210. The applicator connector threads 502 are preferably used to connect the product container 202 to the tire product applicator 106. Applicator connector threads 502 are preferred because the majority of tire polishing products, and other tire surface treatment products, are offered in a product container 202 having a threaded opening and cap for ease of use and storage. However, under appropriate circumstances, the applicator connector threads 502 may have a different configuration, such as a single thread for use on a snap-type top product container 202, etc. As shown in FIG. 5, product delivery channel 504 is preferably in substantial contact with the surface of applicator head 206, allowing product to flow freely through applicator body aperture 402 to applicator head 206. However, under appropriate circumstances, such as the viscosity of the product being used, product delivery channel 504 may provide additional means to regulate the flow of product to applicator head 206, for example through perforations, etc. Applicator head 206 is preferably attached to applicator body 204 at applicator body mounting support 506. Preferably, applicator head 206 is attached to applicator body mounting support 506 by an adhesive. Applicator body mounting support 506 is preferably at the perimeter rim of applicator body 204, as shown. However, under appropriate circumstances, such as when additional applicator body 204 structural support or a more durable attachment between applicator body 204 and applicator head 206 is desired, applicator body mounting support 506 may also be provided in additional locations on the applicator body 204, such as longitudinally across applicator body 204, etc., such that flow of product through product delivery channel 504 is not adversely impacted. Additionally, upon reading the teachings of this specification, those with ordinary skill in the art, will now understand that, under appropriate circumstances, considering issues such as user preferences, economic considerations, durability of the tire product applicator, expected number of uses (throw away or not), manufacturing process, etc., other methods for attaching applicator head 206 to applicator body 204, may suffice. For example, such as using a slightly larger applicator head 206 and lodging it within the applicator body mounting support 506, etc.

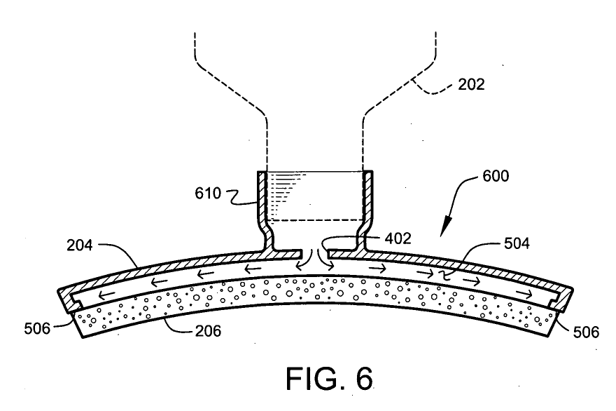

FIG. 6 is a cross-sectional view of the tire product applicator 600, according to another preferred embodiment of the present invention. As shown, this preferred embodiment of the tire product applicator 600 has universal applicator connector 610, such that universal connector 610 preferably fits most sizes of product container 202 openings. Preferably, applicator body 204 and universal applicator connector 610 are made of a durable, flexible material, for example stretchable jelly PVC, rubber, etc., such that universal applicator connector 610 can be stretched over various sizes of product container 202 openings, as shown in FIG. 6. However, under appropriate circumstances, the material the universal applicator connector 610 and applicator body 204 is made of may vary, depending on the durability of the tire product applicator, expected number of uses (throw away or not), manufacturing process, etc. Additionally, however, the applicator body 204 and universal applicator connector 610 may preferably be made of different materials. For example, the applicator body 204 may be made of a more rigid plastic, etc., while the universal applicator connector 610 made of stretchable jelly PVC, etc. This may be accomplished by having an aperture in the applicator body 204, appropriately sized to accommodate universal applicator connector 610, and universal applicator connector 610 with a flared lip, sized larger than the aperture in the applicator body 204, such that when universal applicator connector 610 is pulled through the aperture on the inside of applicator body 204 it would not slip through. Depending on the tightness of the fit, as manufactured, the flared lip of the universal applicator connector 610 may be attached, as necessary, to the applicator body 204 with an adhesive, etc. Other methods of using different materials for applicator body 204 and universal applicator connector 610 in combination and attaching, as necessary, are well known to those skilled in the art, and under appropriate circumstances, such as user preference, economic considerations, etc., may suffice.

Under appropriate circumstances, the applicant's system and device for applying tire polish to a tire sidewall may be used with other products for tires, such as tire cleaning or protectant type products. Additionally, the tire product applicator device may, under appropriate circumstances, be used to apply tire polish by the user by applying the polish directly to the applicator head and then applying the product directly onto the tire sidewall.

Although applicant has described applicant's preferred embodiments of this invention, it will be understood that the broadest scope of this invention includes such modifications as diverse shapes and sizes and materials. Further, many other, advantages of applicant's invention will be apparent to those skilled in the art from the above descriptions and the below claims.

The embodiments of the invention in which an exclusive property or privilege is claimed are defined as follows:

1. A tire product applicator device for applying tire surface treatment products to a tire sidewall, comprising:
a) applicator body for aiding in delivery of tire surface treatment product from a product container to a tire sidewall;
b) applicator head, comprising at least one mounting side and at least one working side wherein said at least one working side comprises concave curvature, for complementally applying tire surface treatment product to a tire sidewall;
c) at least one connector for connecting said applicator body to a product container;
d) product delivery channel for delivering tire surface treatment product from a product container through said at least one connector and said applicator body to said applicator head; and
g) wherein said at least one connector is substantially universal, structured and arranged to fit most conventional product containers commercially offered and available to consumers of tire surface treatment products.

2. The tire product applicator device of claim 1 wherein said product delivery channel is in substantial contact with said applicator head, such that the distribution of flow of tire surface treatment product is not restricted between said delivery channel and said applicator head.

3. The tire product applicator device of claim 1 wherein said at least one connector comprises flexible material, such that said at least one connector can be stretched to fit over various sizes of product container openings.

4. The tire product applicator device of claim 1 wherein said at least one connector comprises at least one connector thread.

5. The tire product applicator device of claim 1 wherein said applicator body comprises a plurality of edges that are beveled on an inward angle.

6. The tire product applicator device of claim 1 wherein said applicator head further comprises a plurality of edges that are beveled on an inward angle.

7. The tire product applicator device of claim 1 wherein said applicator body further comprises formed plastic.

8. The tire product applicator device of claim 1 further comprising at least one mounting support for mounting said mounting side of said applicator head to said applicator body.

9. The tire product applicator device of claim 1 wherein said applicator head further comprises material sufficiently porous to allow tire surface treatment product transfer through said applicator head to a tire sidewall.

10. The tire product applicator device of claim 8 wherein said mounting side of said applicator head is mounted to said at least one mounting support using adhesive.

11. The tire product applicator device of claim 1 wherein said tire applicator device is about 1 inch in width, about 4 inches in length, and about 5 inches in height.

12. A kit comprising:
a) at least one tire product applicator device, comprising:
i) applicator body for aiding in delivery of tire surface treatment product from a product container to a tire sidewall;
ii) at least one applicator head, comprising a mounting side and a working side wherein said working side comprises concave curvature, for complementally applying tire surface treatment product to a tire sidewall;
iii) at least one connector for connecting said applicator body to a product container;
iv) product delivery channel for delivering tire surface treatment product from a product container through said at least one connector and said applicator body to said at least one applicator head; and
v) wherein said at least one connector is substantially universal, structured and arranged to fit most conventional product containers commercially offered and available to consumers of tire surface treatment products;
b) at least one storage container; and
c) at least one set of use instructions.

13. The kit of claim 12 further comprising at least one product container containing tire surface treatment product, wherein said at least one product container comprises a conventional container, such as commercially offered and available to consumers of said tire surface treatment products.

14. The kit of claim 12 wherein said product delivery channel is in substantial contact with said at least one applicator head, such that the distribution of flow of tire surface treatment product is not restricted between said delivery channel and said at least one applicator head.

15. The kit of claim 12 wherein said at least one connector is comprised of flexible material, such that said at least one connector can be stretched to fit over various sizes of product container openings.

16. The kit of claim 12 wherein said at least one connector is comprised of at least one connector thread.

17. The kit of claim 12 wherein said applicator body comprises a plurality of edges that are beveled on an inward angle.

18. The kit of claim 12 wherein said at least one applicator head further comprises a plurality of edges that are beveled on an inward angle.

19. The kit of claim 12 wherein said at least one tire product applicator device further comprises at least one mounting support for mounting said mounting side of said at least one applicator head to said applicator body.

20. The kit of claim 19 wherein said mounting side of said at least one applicator head is mounted to at least one mounting support using adhesive.
